(19) United States
(12) Patent Application Publication
(10) Pub. No.: US 2018/0197197 A1
(43) Pub. Date: Jul. 12, 2018

(54) ROUTING SYSTEMS AND METHODS FOR USE AT RETAIL PREMISES

(71) Applicant: Mastercard International Incorporated, Purchase, NY (US)

(72) Inventors: Amit Kumar Singh, Agra (IN); Ashutosh Sharan, Gurgaon (IN); Mayank Prakash, Dehradun (IN)

(73) Assignee: Mastercard International Incorporated, Purchase, NY (US)

(21) Appl. No.: 15/864,022

(22) Filed: Jan. 8, 2018

(30) Foreign Application Priority Data
Jan. 6, 2017 (SG) 10201700117Q

(51) Int. Cl. G06Q 30/02; G06Q 10/04

(52) U.S. Cl. CPC G06Q 30/0239; G06Q 10/047

(57) ABSTRACT

A routing system for use at a retail premise of a merchant is provided. The retail premise has a plurality of products located at a plurality of sub-regions of the retail premise and the routing system comprises: a routing engine component operable to receive, from a communication device of a consumer, an initial location corresponding to a current location of the consumer within the retail premise, and an offer engine component operable to generate a product offer associated with a said product; wherein the routing engine component is operable to: obtain a target location corresponding to a location of the said product within the retail premise, calculate a route of recommendation between the initial location and the target location based on a popularity score associated with a said sub-region of the retail premise, said popularity score being indicative of an amount of consumer traffic in the sub-region, and transmit the product offer and the route of recommendation to the communication device. Corresponding methods for generating and/or obtaining a route of navigation at a retail premise are also disclosed.

### CROSS-REFERENCE TO RELATED APPLICATIONS

This application claims the priority benefit of Singapore Application Serial No. 10201700117Q, filed Jan. 6, 2017, which is incorporated herein by reference in its entirety.

### TECHNICAL FIELD AND BACKGROUND

The present invention relates to routing systems and methods for use at retail premises, and in particular for generating or obtaining a route of navigation for consumers within the retail premises.

Very often, when consumers shop at retail premises such as grocery stores, he or she usually visit selected sections of the stores which likely house the products he or she is looking for and/or planning to purchase. For example, if a consumer plans to buy fish, or any other kinds of seafood, he or she may enter a grocery store and navigate through the store straight to the seafood section before proceeding to a cashier counter and making a payment for the purchase. In addition, if consumers are familiar with or well informed of the layout of products locations in the store, the consumers are more likely to be able to navigate themselves to those sections directly to locate the products and make purchases for those products only. This reduces the possibility of the consumers visiting other sections of the store and/or making additional purchases of products which the consumer did not consider until having visited the sections. This may also limit the amount of purchases made by consumers and the attractiveness or profitability of the merchants. Therefore, it is desirable to provide an improved method of providing consumers with a route of navigation in retail premises and a routing system for use therein.

### SUMMARY OF THE DISCLOSURE

According to a first aspect, there is provided a method of generating a route of navigation at a retail premise of a merchant. The retail premise has a plurality of products located at a plurality of sub-regions of the retail premise. The method comprises:

a routing engine component receiving, from a communication device of a consumer, an initial location corresponding to a current location of the consumer within the retail premise,

an offer engine component generating a product offer associated with a said product,

obtaining, by the routing engine component, a target location corresponding to a location of the said product within the retail premise,

calculating, by the routing engine component, a route of recommendation between the initial location and the target location based on a popularity score associated with a said sub-region of the retail premise, said popularity score being indicative of an amount of consumer traffic in the sub-region, and

transmitting the product offer and the route of recommendation to the communication device.

In some embodiments, the method may comprise identifying a characteristic associated with the consumer and generating the product offer based on the characteristic.

In some embodiments, the characteristic associated with the consumer may be indicative of past transaction records of the consumer and the method comprises generating the product offer using a database storing past transaction records of the consumer.

In some embodiments, the method may comprise generating the product offer based on one or more products selected by the consumer at the retail premise in real time.

In some embodiments, the method may comprise receiving the target location from a system of the merchant.

In some embodiments, the method may comprise obtaining the target location using a database storing location information of the plurality of products in the retail premise.

In some embodiments, the method may comprise calculating the route of recommendation based on a plurality of popularity scores associated with the respective sub-regions.

In some embodiments, the popularity score may be indicative of the amount of consumer traffic in the sub-region in real-time.

In some embodiments, the amount of consumer traffic may be indicative of one or more of the following:

(i) a count of visits made by consumers to the sub-region;
(ii) a frequency of visits made by consumers to the sub-region; and
(iii) a duration of visits made by consumers to the sub-region.

In some embodiments, the route of recommendation may traverse a plurality of designated sub-regions of the retail premise. Each of the designated sub-regions may be a said sub-region associated with a popularity score that is below a threshold score.

In some embodiments, the method may comprise generating a plurality of candidate routes between the initial location and the target location, and selecting a candidate route traversing a maximum number of the designated sub-regions as the route of recommendation.

In some embodiments, the method may comprise transmitting the route of recommendation to the communication device to cause a map of the retail premise comprising a visual marking of the route of recommendation on the map to be displayed via the communication device to the consumer.

In some embodiments, the method may comprise a route-tracking engine component tracking a route undertaken by the consumer to the target location and determining if the route matches the route of recommendation.

In some embodiments, the method may comprise causing the product offer to be applied to a purchase of the product only in response to the determination being positive.

In some embodiments, the offer engine component may determine if the product associated with the product offer is selected by the consumer.

In some embodiments, the method may comprise generating, in response to a determination that product has been selected by the consumer, a further product offer associated with a further product. The further product offer may be generated based on the product selected by the consumer.

In some embodiments, the method may comprise updating the database to include current purchasing records of the consumer in response to completion of payment.

According to a second aspect, there is provided a routing system for use at a retail premise of a merchant. The apparatus has a processor and a data storage device storing program instructions being operative to cause the processor to carry out any one of the method described above.

According to another expression, there is provided a routing system for use at a retail premise of a merchant. The retail premise has a plurality of products located at a plurality of sub-regions of the retail premise. The routing system comprises:

a routing engine component operable to receive, from a communication device of a consumer, an initial location corresponding to a current location of the consumer within the retail premise, and

an offer engine component operable to generate a product offer associated with a said product;

wherein the routing engine component is operable to:

obtain a target location corresponding to a location of the said product within the retail premise,

calculate a route of recommendation between the initial location and the target location based on a popularity score associated with a said sub-region of the retail premise, said popularity score being indicative of an amount of consumer traffic in the sub-region, and

transmit the product offer and the route of recommendation to the communication device.

In some embodiments, the offer engine component may be operable to identify a characteristic associated with the consumer and to generate the product offer based on the characteristic.

In some embodiments, the characteristic associated with the consumer may be indicative of past transaction records of the consumer and the offer engine component may be operable to generate the product offer using a database storing past transaction records of the consumer.

In some embodiments, the product offer may be generated based on one or more products selected by the consumer at the retail premise in real time.

In some embodiments, the routing engine component may be operable to receive the target location from a system of the merchant.

In some embodiments, the target location may be obtained using a database storing location information of the plurality of products in the retail premise.

In some embodiments, the route of recommendation may be calculated based on a plurality of popularity scores associated with the respective sub-regions.

In some embodiments, said popularity score may be indicative of the amount of consumer traffic in the sub-region in real-time.

In some embodiments, the amount of consumer traffic may be indicative of one or more of the following:

(i) a count of visits made by consumers to the sub-region;
(ii) a frequency of visits made by consumers to the sub-region; and
(iii) a duration of visits made by consumers to the sub-region.

In some embodiments, the route of recommendation may traverse a plurality of designated sub-regions of the retail premise. Each of said designated sub-regions is a said sub-region associated with a popularity score that is below a threshold score.

In some embodiments, the routing engine component may be operable to generate a plurality of candidate routes between the initial location and the target location, and select a candidate route traversing a maximum number of the designated sub-regions as the route of recommendation.

In some embodiments, the routing engine component may be operable transmit the route of recommendation to the communication device to cause a map of the retail premise comprising a visual marking of the route of recommendation on the map to be displayed via the communication device to the consumer.

In some embodiments, the routing system may further comprise a route-tracking engine component operable to track a route undertaken by the consumer to the target location and to determine if the route matches the route of recommendation.

In some embodiments, the offer engine component may cause the product offer to be applied to a purchase of the product only in response to the determination being positive.

In some embodiments, the offer engine component may be operable to determine if the product associated with the product offer is selected by the consumer.

In some embodiments, the offer engine component may be operable to generate, in response to a determination that product has been selected by the consumer, a further product offer associated with a further product. The further product offer may be generated based on the product selected by the consumer.

The present disclosure further proposes a server software product, such as at a time when it is stored in a non-transitory form on a tangible data storage device. The data storage device may be within the server, or it may be a database from which the server is able to download the software. In particular, there is proposed a server program product comprising computer program instructions which is operative, when implemented by a processor of a server, to cause the processor to perform any one of the methods described above.

According to a third aspect, there is provided a method of obtaining a route of navigation at a retail premise of a merchant. The retail premise has a plurality of products located at a plurality of sub-regions of the retail premise. The method comprises:

detecting, by a positioning unit of a communication device of a consumer, an initial location corresponding to a current location of the consumer within the retail premise,

transmitting, by a communication interface of the communication device, the initial location to a routing system,

receiving, from the routing system, a product offer associated with a said product and a route of recommendation between the initial location and a target location, said target location corresponding to a location of the said product within the retail premise, and

displaying, via a graphic user interface of the communication device, the product offer and a map of the retail premise, said map comprising a visual marking of the route of recommendation.

In some embodiments, the communication device may transmit a characteristic associated with the consumer to the routing system, and receive the product offer generated based on the characteristic.

In some embodiments, the method may comprise receiving product information indicating one or more products selected by the consumer at the retail premise in real time.

In some embodiments, the method may comprise receiving the product information from an input by the consumer.

In some embodiments, the method may comprise transmitting the product information to the routing system and receiving the product offer generated based on the product information.

In some embodiments, the method may comprise tracking a route undertaken by the consumer to the target location and determining if the route matches the route of recommendation.

In some embodiments, the method may comprise receiving an electronic coupon which allows the product offer to be applied to a purchase of the product in response to the determination being positive.

In some embodiments, the method may comprise determining if the product associated with the product offer is selected by the consumer.

According to a yet a further aspect, there is provided a communication device. The communication device comprises a processor and a data storage device storing program instructions, the program instructions being operative to perform any one of the methods above.

According to another expression, there is a provided a communication device for use by a consumer, said communication device having:

a positioning unit operable to detect an initial location corresponding to a current location of the consumer within a retail premise, said retail premise having a plurality of products located at a plurality of sub-regions of the retail premise,

a processor configured to:

transmit the initial location to a routing system via a communication interface of the communication device;

receive, from the routing system, a product offer associated with a said product and a route of recommendation between the initial location and a target location, said target location corresponding to a location of the said product within the retail premise, and

a graphic user interface operable to display, to the consumer, the product offer and a map of the retail premise comprising a visual marking of the route of recommendation on the map.

In one embodiment, the processor may be configured to transmit a characteristic associated with the consumer to the routing system, and to receive the product offer generated based on the characteristic.

In one embodiment, the processor may be configured to receive product information indicating one or more products selected by the consumer at the retail premise in real time.

In one embodiment, the processor may be configured to receive the product information from an input by the consumer.

In one embodiment, the processor may be configured to transmit the product information to the routing system and receive the product offer generated based on the product information.

In one embodiment, the positioning unit may be configured to track a route undertaken by the consumer to the target location and to determine if the route matches the route of recommendation.

In one embodiment, the processor may be configured to receive an electronic coupon which allows the product offer to be applied to a purchase of the product, only in response to the determination being positive.

In one embodiment, the processor may be configured to determine if the product associated with the product offer is selected by the consumer.

The present disclosure further proposes a software product, such as at a time when it is stored in a non-transitory form on a tangible data storage device. The data storage device may be within a communication device of a user, or it may be a database from which the communication device is able to download the software. In particular, there is proposed a program product comprising computer program instructions which is operative, when implemented by a processor of a communication device, to cause the processor to perform any one of the methods described above.

All operations of the proposed methods are preferably performed automatically. The term “automatic” is used in this document to refer to a process which is performed substantially without human involvement, save possibly for initiation of the process.

Note that the term “product” is used in this document to include any of physical objects, data products (such as music or software) or services.

Within the scope of this proposed disclosure it is expressly intended that the various aspects, embodiments, examples and alternatives set out in the preceding paragraphs, in the claims and/or in the following description and drawings, and in particular the individual features thereof, may be taken independently or in any combination. Features described in connection with one embodiment are applicable to all embodiments, unless such features are incompatible.

### BRIEF DESCRIPTION OF THE DRAWINGS

Embodiments of the disclosure will now be described by way of example only with reference to the following drawings, in which:

FIG. 1 shows a computerized network which is suitable to perform a method according to the present disclosure;

FIG. 2 is a flow diagram of an exemplary method according to one embodiment;

FIG. 3 is a schematic store map illustrating a route of recommendation generated by the route engine component according to one embodiment;

FIG. 4 is a flow diagram of an exemplary method according to another embodiment;

FIG. 5 is a flow diagram of an exemplary method of calculating a route of recommendation;

FIG. 6 is a flow diagram of an exemplary method of generating a further product offer;

FIG. 7 shows the technical architecture of a server of the computerized network of FIG. 1; and

FIG. 8 shows the technical architecture of a communication device of the computerized network of FIG. 1.

### DETAILED DESCRIPTION

### Overview

In general terms, the present disclosure proposes generating a product offer (e.g. an offer to supply a product, typically, but necessarily, at a discounted price or with other promotional terms) for a given consumer while the consumer visits a retail premise, and providing the consumer with a route of recommendation which connects a current location of the consumer and a target location where the product is located within the retail premise thereby guiding the consumer to the target location. The product offer generated may be customized for a given consumer based on his or her characteristics, such as ones identified from his or her past purchasing records at the retail premise.

The route of recommendation is generated based on popularity scores associated with respective sub-regions within the retail premise. Each sub-region houses a corresponding selection of products for sale at the retail premise. A popularity score associated with a sub-region is indicative of an amount of consumer traffic of that region. For one example, the route of recommendation may be generated such that the consumer may be guided to traverse a number of sub-regions of the retail premise which are generally less popular among consumers. The route of recommendation and the product offer may be transmitted to the consumer's communication device, such as his or her mobile phone. The mobile phone then displays to the consumer, via a graphic user interface, the product offer and a map of the retail premise which includes a visual marking of the route recommendation to guide the consumer to the location of the product. Typically, but not necessarily, the product offer may be applied to the consumer's purchase of the product if it is determined that the consumer has followed the route of recommendation to reach the product.

Accordingly, the proposed method and system not only incentivize the consumers to shop in the merchant's premise (e.g. a store) due to the product offer extended to the consumers, but also helps the merchants to direct consumers to visit designated sub-regions (e.g. those less frequently visited sections) of the store. As a result, this increases the possibility of consumers purchasing more products from the merchants since the consumers may become interested in purchasing products from those sub-regions along the route. Overall, this may not only allow the consumer's shopping experience to be improved but also increase the merchants' sales and profitability. In a preferred embodiment, the method and system further determine if the consumer has added the product associated with the offer in his/her shopping cart. Further product offers may be generated based on this further information, and an associated route of recommendation may be calculated accordingly. For example, if it is determined that the consumer did not add the product in the shopping cart, the system may assume that the consumer is not interested in products of this particular category and may generate a further product offer associated a product which is in a different category.

### DESCRIPTION OF EMBODIMENTS

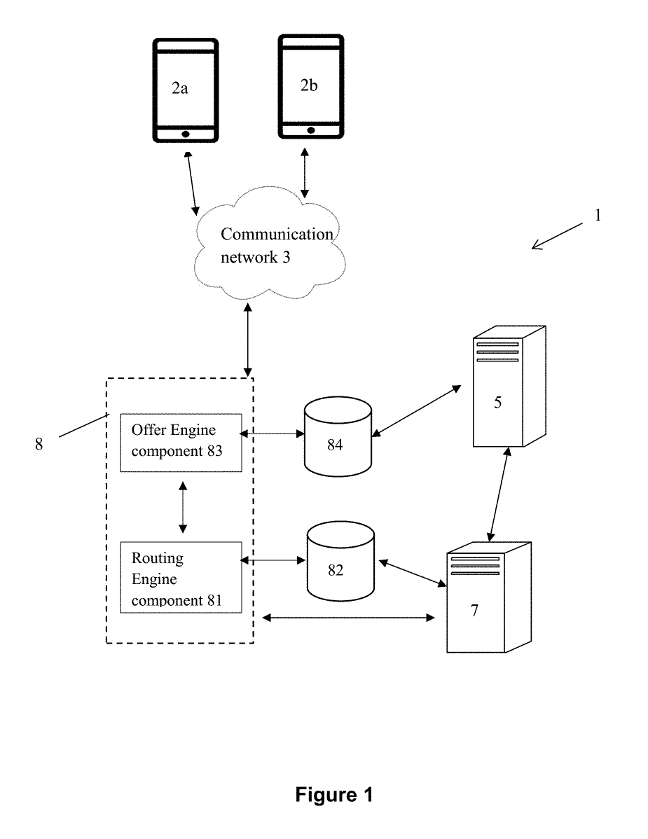

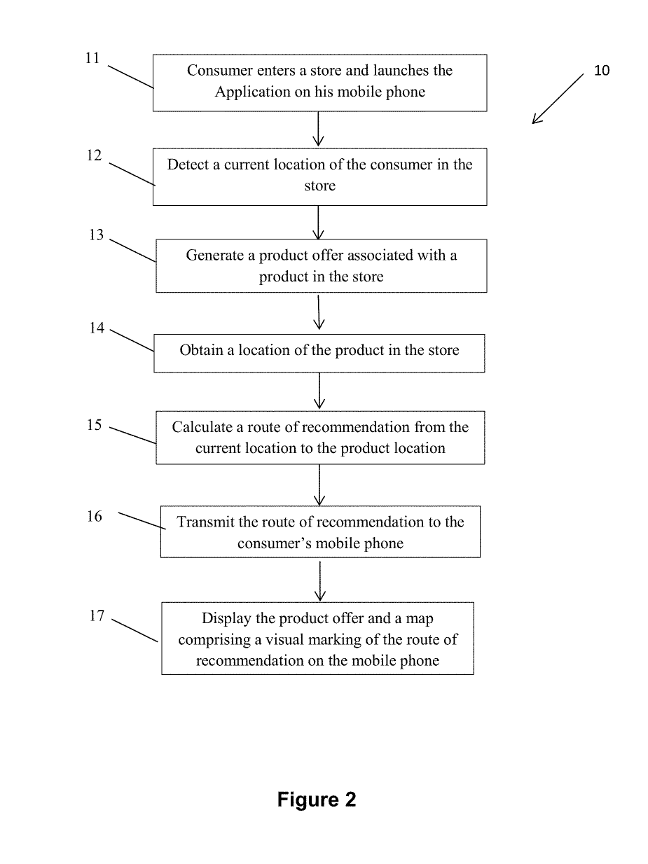

Referring to FIG. 1, a computerized network is shown which is suitable for performing methods of embodiments as illustrated by FIGS. 2-6.

The computerized network includes a routing system 8 having an offer engine component 83 and a routing engine component 81. The routing system 8 is in communication with a location database 82 storing location information associated with a plurality of products provided by a retail premise such as a grocery store. For example, the layout of the store may include a plurality of sub-regions and each of which houses a selection of products for sale. The location information of the products may be stored in a form of a map including associations between individual products and the corresponding sub-regions of the store in which the products are located. As will be understood by a skilled person, the location information of plurality of sub-regions may be represented by a coordinate system, in which different store-map coordinates are assigned to the respective sub-regions of the store. The routing engine component 81 may use the coordinates corresponding to different sub-regions to calculate routes of navigation through the store, as will be described later.

The routing system 8 is further in communication with a transaction records database 84 storing past transaction records of consumers. The transaction records may include records of transactions made by a consumer with the present merchant that the consumer is currently visiting, or with other merchants in the same or a different type of businesses. The transaction records may include records of past transactions made by the consumer using his or her payment card(s), such as credit card or debit card, over a payment network. According to a particular example, the transaction records database 84 may include stock keeping unit (SKU)-level transaction data. For example, the transaction database may store the SKU transaction data which includes one or more of the following: transaction key, store name, store location, individual key, store ID, date of purchase, time of purchase, basket ID, basket total spend, total number of items purchased, number of each product purchased, product codes, product descriptions, individual product prices, any discounts or offers redeemed etc.

In the embodiment illustrated by FIG. 1, the routing system 8 is further in communication with a server 7 associated with the merchant. In some embodiments, the routing system 8 is configured to receive information (such as cart information of Internet-of-things-enabled shopping carts at the retail premise of the merchant) from the merchant's server 7, as will be described later. The merchant's server 7 may further be in communication with the location database 82 to maintain and/or update the records relating to the location information of products in the store in real-time or at regular time intervals. In another embodiment, the merchant's server 7 stores the location database 82 and is configure to allow access by the routing system 8 to retrieve the location information.

As will be understood by a skilled person in the art, the transaction records database 84 may be maintained and/or updated by a payment network server 5 of the payment network in respect of recent transactions. The payment network server 5 may be constituted by a payment processing organization such as Mastercard®, having suitable processing apparatus. The update may be carried out in real-time or at regular time intervals.

The offer engine component 83 is configured to generate a product offer for a product in the store using consumers' transaction records stored in the transaction records database 84. In some embodiments, the product offer may be customized for consumers based on a characteristic associated with the consumer. In one example, consumers may be pre-classified into respective consumer categories based on characteristics extracted from their past transaction records. In another embodiment, the product offer may be customized for each individual consumer based on his or her past transaction records. In another example, the product offer may be generated based on one or more products selected by the consumer at the retail premise. Typically, the consumers may be identified by an associated communication address (e.g. IP address or phone number), or a unique identifier (such as a user ID) which the consumer previously registered with the routing system 8 and/or the merchant's server 7, as will be described in more detail later.

As illustrated by FIG. 1, the routing system 8 is in communication with a plurality of communication devices, such as consumers' mobile phones 2a, 2b, via a communication network 3. It will be understood that in another embodiment, the communication device may be another portable communication device such as a tablet computer. Yet in another embodiment, the communication device may be a smart watch or other wearable devices, which has a graphic user interface, and a network interface which allows for data transmission to and from the routing system 8. Each of the various devices/servers in the computerized network 1 has a communication module such as wireless interface for two-way communication between one and another via a communication network. The communication network could be any types of network, for example, virtual private network (VPN), the Internet, a local area and/or wide area network (LAN and/or WAN), 3G, 4G and so on, as will be understood by a stilled person.

Exemplary methods of the present disclosure will now be illustrated with reference to FIGS. 2-6 in which the operations are enumerated. It should also be noted that enumeration of operations is for purposes of clarity and that the operations need not be performed in the order implied by the enumeration.

FIG. 2 illustrates an exemplary method 10 of providing a route of navigation for a consumer within a retail premise of a merchant, such as a grocery store, according to the present disclosure.

At step 11, a consumer enters the grocery store and launches a mobile application installed on his mobile phone 2a. For a first time user, the mobile application may require the user (i.e. the consumer) to sign up and create a user's account through a registration process. For example, the consumer may be prompted to provide certain basic information about the user, such as one or more of the following: the user's name, gender, address, contact details, age, etc. The consumer may also provide details of a payment mechanism, such as a credit card or debit card number, or a digital wallet details, so that past transaction records relating to the payment mechanism may be identified and become associated with the consumer. The past transaction records may be used to generate a customized product offer which may interest the consumer. In some embodiments, each consumer is identified by a user ID, which allows the consumer to be uniquely identified by the proposed system.

At step 12, a current location of the consumer in the grocery store is detected. This may be detected by a positioning unit, such as a geo-location module, of the consumer's mobile phone 2a. The detection may be initiated in response the consumer launching the mobile application on the mobile phone 2a. The mobile phone 2a is configured to transmit location data encoding the current location of the consumer to the routing engine component 81 of the routing system 8 for processing.

At step 13, the offer engine component 83 of the routing system 8 generates a product offer associated with a product (including a type of products), in the store, for example, 50% off on purchase of 5 Kg pack of Kellogg's cornflakes. The product offer may be automatically generated upon the consumer launches the mobile application within the merchant's premise. The product offer may be generated based on a characteristic of the consumer. The characteristic of the consumer may be extracted based on any basic information of the consumer provided during the registration process. The characteristic may alternatively or additionally be a characteristic indicative of the consumer's past transaction records.

In one embodiment, each consumer may be associated with a respective consumer category based on one or more characteristics of the consumer. The offer engine component 83 may generate a product offer based on a pre-classified consumer category with which the consumer is associated. For example, the classification of consumer categories may be based on a category of most frequently bought products, a total amount of money spent during a certain period, the consumer's price-sensitivity level, or the like, which may be extracted from the consumer's past transaction records. For each consumer category, a pre-determined list of product offers relating to one or more products may be populated and stored by a product offer database (not shown). Correspondingly, the offer engine component 83 may be configured to select, for a given consumer, a product offer from the pre-determined list corresponding to the consumer category. In another embodiment, the product offer may be customized for each individual consumer based on his or her past transaction records. In another example, the product offer may be generated based on one or more products selected by the consumer at the retail premise in real time.

At step 14, the routing engine component 81 is configured to obtain a location of the product in the store. In particular, the routing engine component 81 may interrogate the location database 82 to retrieve the location information of the product in the grocery store. The location information is stored in a form of a map including associations between individual products and their corresponding sub-regions of the grocery store in which the products are located. The plurality of sub-regions is represented by a coordinate system in which different coordinates are assigned to the respective sub-regions of the store. The location database 82 further includes, for each coordinate, a respective popularity score describing an amount of consumer traffic at the corresponding sub-region of the store. In this example, the amount of consumer traffic is indicative of a count of visits made by consumers to the sub-region during a specific period of time. In another example, the amount of consumer traffic may be indicative of a frequency of visits made by consumers to the sub-region, and/or a duration of visits made by consumers to the sub-region. In another example, the popularity score is indicative of the amount of consumer traffic in the sub-region in real time. In one particular example, the consumer traffic is determined using video footages monitoring respective sub-regions of the store, such as those detected by CCTV cameras. A skilled person would understand that other sensors for detecting consumer traffic may be used, such as infrared cameras and/or sensors.

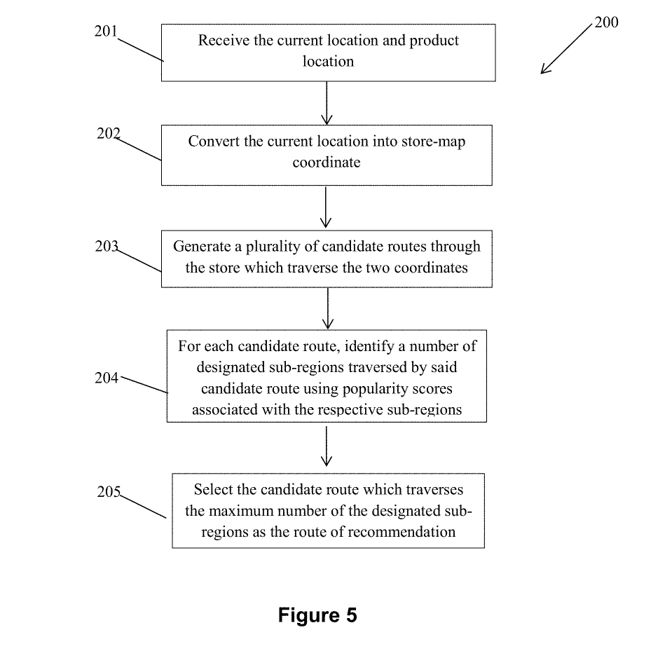

At step 15, the routing engine component 81 is configured to calculate a route of recommendation from the current location to the product location. An exemplary embodiment of calculating a route of recommendation will be described later in more detail with reference to FIG. 5.

At step 16, the routing engine component 81 is configured to transmit the route of recommendation to the consumer's mobile phone 2a. At step 17, the mobile phone 2a is configured to display the product offer and a map including a visual marking of the route of recommendation. In one embodiment, the routing engine component 81 is configured to transmit the map data characterizing a map representing the layout of the grocery store together with the route of recommendation to the mobile phone 2a for rendering the map including the visual marking by the mobile phone 2a. The map may be rendered in a two-dimensional (planar) or a three-dimensional format. In another embodiment, the map data representing the store layout may be pre-loaded on the mobile phone 2a by the mobile application or received from the merchant's server 7 instead. The mobile phone 2a may render a graphic representation by proper registering the route of recommendation to the map. According to one example, the mobile phone 2a may be configured to display the route of recommendation against an instantaneous image or view of the retail premise captured by a camera of the mobile phone 2a to give the consumer augmented reality experience.

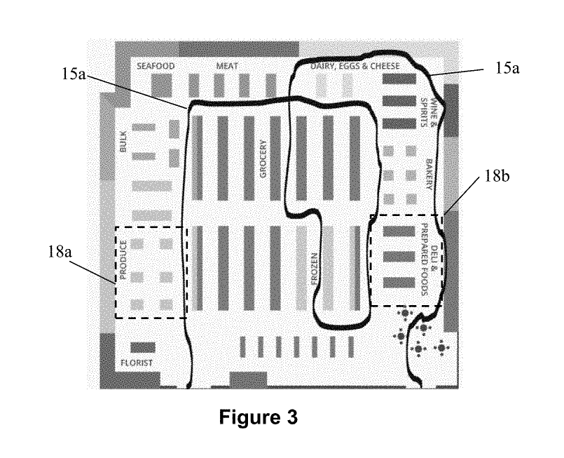

FIG. 3 illustrates a route of recommendation 15a generated by the route engine component 81 according to one embodiment. As shown, the grocery store is divided into a plurality of sub-regions represented by sections such as “Florist”, “Produce” 18a, “Bulk”, “Seafood”, “Deli & Prepared food” 18b etc. In this example, for a current location at the “Produce” section 18a and a product location at the “Deli & Prepared Foods” section 18b, the routing engine component 81 is configured to generate a route of recommendation 15a which is much more tortuous than a direct route that connects the two sections 18a, 18b. In particular, the route of recommendation 15a traverses a plurality of sub-regions of the grocery store and the route 15a covers a substantially larger number of sub-regions than the number of sub-regions which would be covered by at a shortest available route between the two sections 18a, 18b. As such, by encouraging the consumer to follow the route of recommendation 15a when navigating to the product location, the consumer is guided to visit many more other sections of the grocery store. Therefore, the probability of the consumer making additional purchases of products in those sections will likely increase, since the consumer may not otherwise visit those sections.

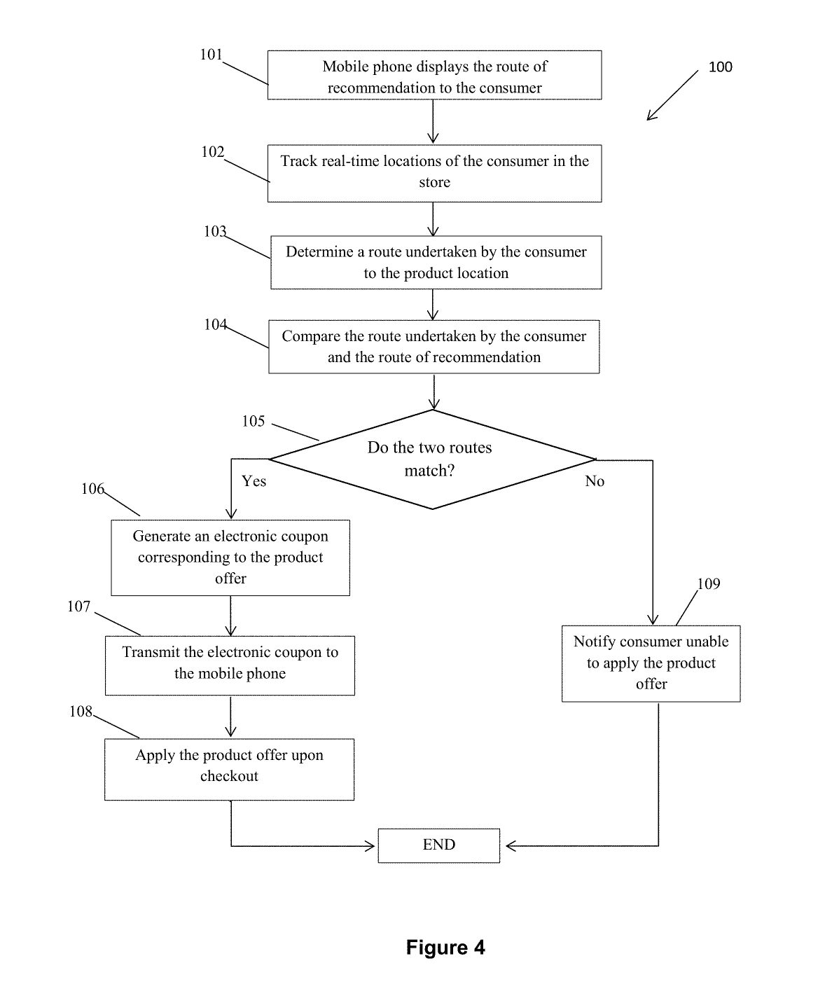

Turning to FIG. 4, which illustrates a flow of another exemplary method 100 of the present disclosure. Steps 101-105 of the method 100 are optional, and they may be used in addition to the steps 11-17 of the method 10 described above.

Following the mobile phone 2a displaying the route of recommendation to the consumer at step 101, the geo-location module, such as a GPS, of the mobile phone 2a tracks real-time locations of the consumer in the store at step 102. Based on the tracked locations, a route undertaken by the consumer to the product location may be determined at step 103. The route may be mapped to store coordinates corresponding to the respective sub-regions of the store which is traversed by the route.

At steps 104-105, a comparison is made between the route undertaken by the consumer and the route of recommendation, and a determination may be made as to whether the two routes match. The comparison and determination may be made, for example, by calculating a discrepancy score between the two routes. The discrepancy score may be calculated based on the similarity of the plurality of store coordinates covered by one route and those covered by the other route. In other words, the proximity between the sub-regions respectively traversed by each route may be used in the comparison. The calculation may be performed by the mobile phone 2a itself, or by the routing engine component 81. In the latter case, the mobile phone 2a may send the tracked locations of the consumer to the routing engine component 81. The routing engine component 81 calculates the discrepancy score after receiving the tracked locations from the mobile phone 2a. A predefined threshold may be set for the discrepancy score so that if the discrepancy score is above or equal to the threshold, it is determined that the two routes do not match. If the discrepancy score is below the threshold, the two routes are determined as matching.

If it is determined that the two routes match at step 105, the offer engine component 83 may electronically generate an electronic coupon corresponding to the product offer, and the electronic coupon may be transmitted to the consumer's mobile phone 2a at step 107. The electronic coupon enables the product offer to be applied to the product upon the consumer checking out at step 108.

Alternatively, it is envisaged that the offer engine component 83 may not electronically generate the coupon and transmitting it to the consumer's mobile phone 2a. Instead, the offer engine component 83 may communicate with the merchant's server 7 so that when the consumer checks out at a merchant's terminal, the merchant's server 7 applies the product offer to the consumer's purchase automatically by identifying the consumer, for example based on the consumer's user ID at a checkout counter of the store.

If it is determined that the two routes do not match at step 105, the offer engine component 83 may accordingly notify the consumer at step 109 that the product offer is not available to the consumer as the route of recommendation was not followed. For example, a message may be displayed via the mobile application's interface via the consumer's mobile phone 2a.

FIG. 5 illustrates an exemplary method 200 of calculating a route of recommendation by the route engine component 81 according to one embodiment.

At step 201, the routing engine component 81 obtains the current location and the product location. Similarly, the current location may be received form the mobile phone 2a of the consumer, and the product location may be obtained by interrogating the location database 82. In this example, the product location is stored in the location database in a form of store-map coordinates corresponding to the sub-region of the store which house that particular product.

In one particular example, the current location received by the routing engine component 81 may be in a form of GPS coordinates. At step 202, the current locations may be converted into the corresponding coordinates by mapping the location into the store-map. In another example, the current location of the consumer may be detected by in-store positioning sensors, such as a Bluetooth receiver installed at the store premise. This may improve the accuracy of the positioning information associated with the consumer.

At step 203, the routing engine component 81 generates a plurality of candidate routes through the store which traverse the two coordinates corresponding to the current and product locations. Typically, each candidate route traverses a plurality of coordinates representing successive sub-regions of the store between the current and product locations.

At step 204, the routing engine component 81 selects a route of recommendation from the plurality of candidate routes according to a pre-determined criterion and. In one particular example, the routing engine component 81 is configured to identify a number of designated sub-regions traversed by each of the candidate routes. The designated sub-regions are identified using information relating to the popularity scores stored in the location database 82. The designated sub-regions are, for example, sub-regions of the store, each of which being associated with a popularity score of a pre-defined range. In this example, a sub-region whose popularity score is below a threshold value is identified as the designated sub-region. In other words, the designated sub-regions may correspond to sections of the store which are generally less frequently visited by consumers in the store. The threshold value may be selected based on a profile of the popularity scores across all sub-regions in the store. In a particular example, the threshold value may be set such that the sub-regions whose popularity score is below 20 percentile of the popularity score distribution across all sub-regions will be identified as the designated sub-regions. In this embodiment, for each candidate route, the routing engine component 81 calculates the number of the designated sub-regions traversed by the candidate route and selects the one which traverse the maximum number of the designated sub-regions as the route of recommendation to the consumer at step 205. It will be understood by a skilled person that the route of recommendation may additionally or alternatively be selected based on another pre-determined criterion. For example, the route of recommendation may be selected as a route which covers a shortest distance between the two locations while traversing at least a pre-determined number or range of numbers (e.g. 5 or 5-10) of the designated sub-regions. This may encourage consumers to visit other sections of the store (especially those less popular sections more often) thereby increasing the size of basket as well as the possibility of product items located in those sections being selected and purchased by consumers at those designated sub-regions.

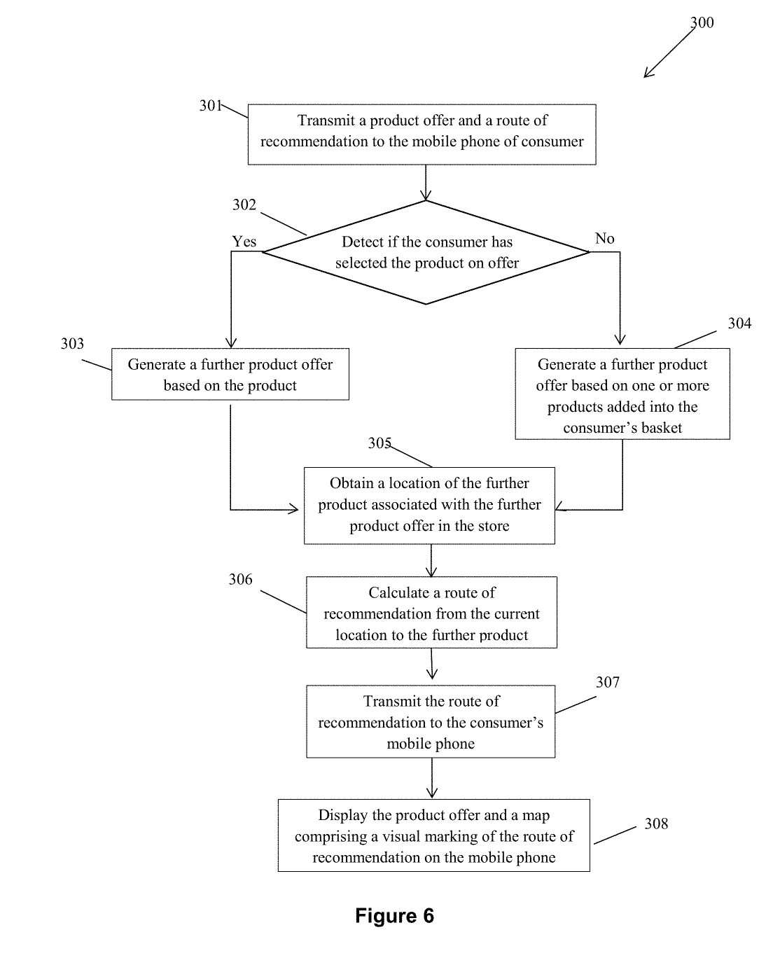

Turning to FIG. 6, a method 300 is illustrated for generating a further product offer according to a further embodiment of the present disclosure.

Following receiving a product offer and a route of recommendation by the mobile phone 2a of the consumer at step 301, the routing system 8 may determine if the consumer has selected the product on offer at step 302. In one embodiment, the routing system 8 may receive relevant information transmitted from the mobile phone 2a of the consumer. For example, the consumer may be asked to confirm if he has selected the product by providing a corresponding command via the mobile application. This may be done by the consumer adding the product to a virtue basket in the mobile application or simply confirming (e.g. providing a corresponding input via the mobile application) that he wishes to receive an electronic coupon which enables the offer to be applied at the cashier upon checkout.

In another embodiment, Internet-of-Things (IoT)-enabled shopping devices (such as IoT-enabled shopping carts, or IoT-enabled shopping accessories such as barcodes, beacons, sensors or the like) may be provided by the merchant, which may be used to detect if a product has been put into the cart. Typically, the IoT-enabled carts have communication interface for one-way or two-way communication with the merchant's server 7, and further comprises sensors or readers which are configured to detect and identify tags carried by products which are placed in close proximity to the sensor or reader. As will be appreciated by a skilled person in the art, such identification or detection may employ radio-frequency (RF) communication technologies, such as the radio-frequency identification (RFID), near-field communication (NFC) technologies, or the like. Typically, the merchant's server 7 may monitor cart information (i.e. product information of products contained by the cart) for a plurality of IoT-enabled carts. Each cart may be associated with a unique identifier (such as a serial number in a form of a barcode) which becomes associated with the consumer upon scanning the barcode by the consumer's mobile phone 2a when in use. This establishes an association between the particular cart and associated product information with the particular consumer who is using the cart.

If it is determined at step 302 that the consumer has selected the product on offer, the offer engine component 83 may generated a further product offer based on the current product selected by the consumer at step 303. If it is determined at step 302 that the consumer has not selected the product on offer, the routing system 8 may generate a further product offer at step 304 based on one or more products which have been added into the consumer's shopping cart. Again, products which are selected by the consumer (i.e. added into the consumer's shopping cart or basket) may be detected by the IoT carts provided at the merchant's premises, or by the consumer's addition of selected products to a virtue shopping cart via the mobile application. In another embodiment, the further product offer may be generated based on past transaction records of the consumer too. For example, another product offer may be selected from the pre-determined list containing product offers corresponding to the consumer category.

Based on the generated further product offer, the routing system 8 obtains a location of the further product in the store at step 305, and a route of recommendation from the current location of the consumer to the product location is calculated at step 306. At steps 307-308, the route of recommendation is transmitted to the consumer's mobile phone 2a so that the further product offer and the store map including a visual marking of the route of the recommendation may be displayed to the consumer by the mobile phone 2a. The above steps 305-308 may be performed in the same way as steps 14-17 of method 10 described earlier.

Typically, upon completion of payment, the transaction records database 84 may be updated by the payment network server 5 to include current purchasing records of the consumer.

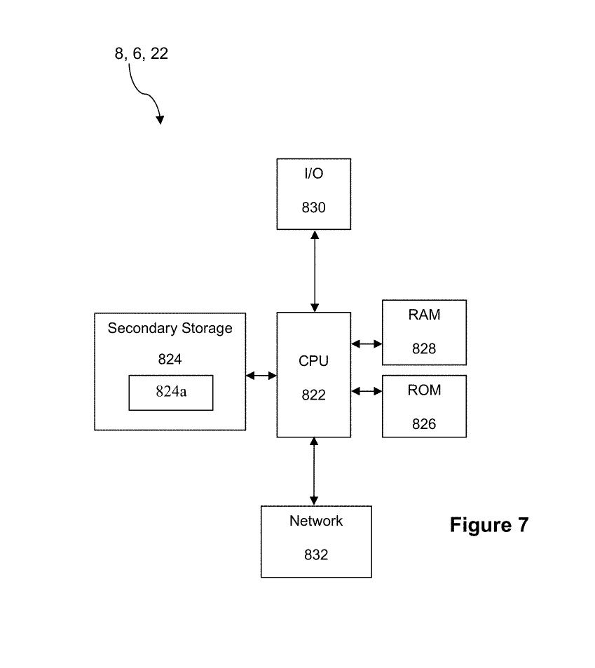

FIG. 7 is a block diagram showing a technical architecture of a server computer (e.g. the routing system 8, merchant's server 7 or payment network server 5) suitable for implementing the present methods.

The technical architecture includes a processor 422 (which may be referred to as a central processor unit or CPU) that is in communication with memory devices including secondary storage 424 (such as disk drives), read only memory (ROM) 426, random access memory (RAM) 428. The processor 422 may be implemented as one or more CPU chips. The technical architecture may further comprise input/output (I/O) devices 430, and network connectivity devices 432.

The secondary storage 424 is typically comprised of one or more disk drives or tape drives and is used for non-volatile storage of data and as an over-flow data storage device if RAM 428 is not large enough to hold all working data. Secondary storage 424 may be used to store programs which are loaded into RAM 428 when such programs are selected for execution.

In this embodiment, the secondary storage 424 has a processing component 424a comprising non-transitory instructions operative by the processor 422 to perform various operations of the method of the present disclosure. The ROM 426 is used to store instructions and perhaps data which are read during program execution. The secondary storage 424, the RAM 428, and/or the ROM 426 may be referred to in some contexts as computer readable storage media and/or non-transitory computer readable media.

I/O devices 430 may include printers, video monitors, liquid crystal displays (LCDs), plasma displays, touch screen displays, keyboards, keypads, switches, dials, mice, track balls, voice recognizers, card readers, paper tape readers, or other well-known input devices.

The network connectivity devices 432 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards that promote radio communications using protocols such as code division multiple access (CDMA), global system for mobile communications (GSM), long-term evolution (LTE), worldwide interoperability for microwave access (WiMAX), near field communications (NFC), radio frequency identity (RFID), and/or other air interface protocol radio transceiver cards, and other well-known network devices. These network connectivity devices 432 may enable the processor 422 to communicate with the Internet or one or more intranets. With such a network connection, it is contemplated that the processor 422 might receive information from the network, or might output information to the network in the course of performing the above-described method operations. Such information, which is often represented as a sequence of instructions to be executed using processor 422, may be received from and outputted to the network, for example, in the form of a computer data signal embodied in a carrier wave.

The processor 422 executes instructions, codes, computer programs, scripts which it accesses from hard disk, floppy disk, optical disk (these various disk based systems may all be considered secondary storage 424), flash drive, ROM 426, RAM 428, or the network connectivity devices 432. While only one processor 422 is shown, multiple processors may be present. Thus, while instructions may be discussed as executed by a processor, the instructions may be executed simultaneously, serially, or otherwise executed by one or multiple processors.

Although the technical architecture is described with reference to a computer, it should be appreciated that the technical architecture may be formed by two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the technical architecture to provide the functionality of a number of servers that is not directly bound to the number of computers in the technical architecture. In an embodiment, the functionality disclosed above may be provided by executing the application and/or applications in a cloud computing environment. Cloud computing may comprise providing computing services via a network connection using dynamically scalable computing resources. A cloud computing environment may be established by an enterprise and/or may be hired on an as-needed basis from a third-party provider.

It is understood that by programming and/or loading executable instructions onto the technical architecture, at least one of the CPU 422, the RAM 428, and the ROM 426 are changed, transforming the technical architecture in part into a specific purpose machine or apparatus having the novel functionality taught by the present disclosure. It is fundamental to the electrical engineering and software engineering arts that functionality that can be implemented by loading executable software into a computer can be converted to a hardware implementation by well-known design rules.

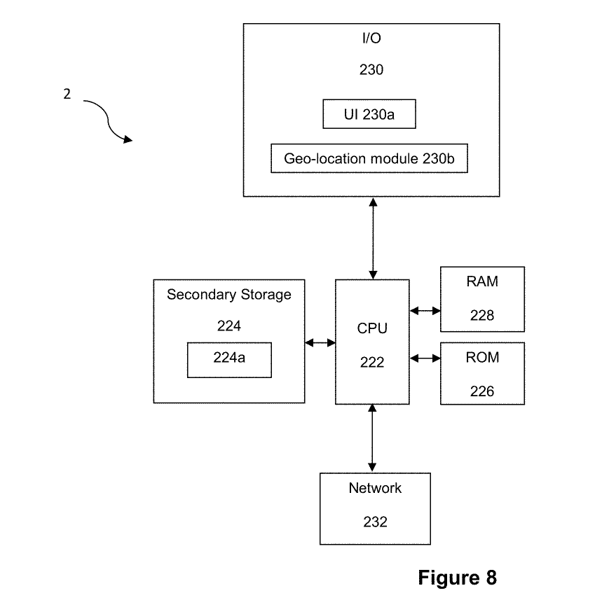

FIG. 8 is a block diagram showing a technical architecture of a communication device (e.g. the consumer's mobile phone 2a, 2b). The technical architecture includes a processor 222 (which may be referred to as a central processor unit or CPU) that is in communication with memory devices including secondary storage 224 (such as disk drives or memory cards), read only memory (ROM) 226, random access memory (RAM) 228. The processor 222 may be implemented as one or more CPU chips. The technical architecture further comprises input/output (I/O) devices 230, and network connectivity devices 232.

The I/O devices comprise a consumer interface (UI) 230a and a geo-location module 230b. The UI 230a may comprise a screen in the form of a touch screen, a keyboard, a keypad or other known input device. The geo-location module 230b may be a global positioning system (GPS) or any other module capable of determining a geographic location of an object.

The secondary storage 224 is typically comprised of a memory card or other storage device and is used for non-volatile storage of data and as an over-flow data storage device if RAM 228 is not large enough to hold all working data. Secondary storage 224 may be used to store programs which are loaded into RAM 228 when such programs are selected for execution.

In this embodiment, the secondary storage 224 has a processing component 224a, comprising non-transitory instructions operative by the processor 222 to perform various operations of the method of the present disclosure. The ROM 226 is used to store instructions and perhaps data which are read during program execution. The secondary storage 224, the RAM 228, and/or the ROM 226 may be referred to in some contexts as computer readable storage media and/or non-transitory computer readable media.

The network connectivity devices 232 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards that promote radio communications using protocols such as code division multiple access (CDMA), global system for mobile communications (GSM), long-term evolution (LTE), worldwide interoperability for microwave access (WiMAX), near field communications (NFC), radio frequency identity (RFID), and/or other air interface protocol radio transceiver cards, and other well-known network devices. These network connectivity devices 232 may enable the processor 222 to communicate with the Internet or one or more intranets. With such a network connection, it is contemplated that the processor 222 might receive information from the network, or might output information to the network in the course of performing the above-described method operations. Such information, which is often represented as a sequence of instructions to be executed using processor 222, may be received from and outputted to the network, for example, in the form of a computer data signal embodied in a carrier wave.

The processor 222 executes instructions, codes, computer programs, scripts which it accesses from hard disk, floppy disk, optical disk (these various disk based systems may all be considered secondary storage 224), flash drive, ROM 226, RAM 228, or the network connectivity devices 232. While only one processor 222 is shown, multiple processors may be present. Thus, while instructions may be discussed as executed by a processor, the instructions may be executed simultaneously, serially, or otherwise executed by one or multiple processors.

Whilst the foregoing description has described exemplary embodiments, it will be understood by those skilled in the art that many variations of the embodiment can be made within the scope and spirit of the present disclosure. For example, the routing system 8 may work with a plurality of merchants and retail premises to allow the consumers utilize the routing system 8 at different retail locations and stores.

1. A routing system for use at a retail premise of a merchant, said retail premise having a plurality of products located at a plurality of sub-regions of the retail premise, the routing system comprising:
a routing engine component operable to receive, from a communication device of a consumer, an initial location corresponding to a current location of the consumer within the retail premise, and
an offer engine component operable to generate a product offer associated with a said product;
wherein the routing engine component is operable to:
obtain a target location corresponding to a location of the said product within the retail premise,
calculate a route of recommendation between the initial location and the target location based on a popularity score associated with a said sub-region of the retail premise, said popularity score being indicative of an amount of consumer traffic in the sub-region, and
transmit the product offer and the route of recommendation to the communication device.

2. The routing system according to claim 1, wherein the offer engine component is operable to identify a characteristic associated with the consumer and to generate the product offer based on the characteristic.

3. The routing system according to claim 2, wherein the characteristic associated with the consumer is indicative of past transaction records of the consumer and the offer engine component is operable to generate the product offer using a database storing past transaction records of the consumer.

4. The routing system according to claim 2, wherein the product offer is generated based on one or more products selected by the consumer at the retail premise in real time.

5. The routing system according to claim 1, wherein the routing engine component is operable to receive the target location from a system of the merchant.

6. The routing system according to claim 1, wherein the target location is obtained using a database storing location information of the plurality of products in the retail premise.

7. The routing system according to claim 1, wherein the route of recommendation is calculated based on a plurality of popularity scores associated with the respective sub-regions.

8. The routing system according to claim 1, wherein said popularity score is indicative of the amount of consumer traffic in the sub-region in real-time.

9. The routing system according to claim 1, wherein the amount of consumer traffic is indicative of one or more of the following:
(i) a count of visits made by consumers to the sub-region;
(ii) a frequency of visits made by consumers to the sub-region; and
(iii) a duration of visits made by consumers to the sub-region.

10. The routing system according to claim 1, wherein the route of recommendation traverses a plurality of designated sub-regions of the retail premise, each of said designated sub-regions being a said sub-region associated with a popularity score that is below a threshold score.

11. The routing system according to claim 10, wherein the routing engine component is operable to generate a plurality of candidate routes between the initial location and the target location, and select a candidate route traversing a maximum number of the designated sub-regions as the route of recommendation.

12. The routing system according to claim 1, wherein the routing engine component is operable transmit the route of recommendation to the communication device to cause a map of the retail premise comprising a visual marking of the route of recommendation on the map to be displayed via the communication device to the consumer.

13. The routing system according to claim 1, further comprising a route-tracking engine component operable to track a route undertaken by the consumer to the target location and to determine if the route matches the route of recommendation.

14. The routing system according to claim 13, wherein the offer engine component cause the product offer to be applied to a purchase of the product only in response to the determination being positive.

15. The routing system according to claim 1, wherein the offer engine component is operable to determine if the product associated with the product offer is selected by the consumer.

16. The routing system according to claim 15, wherein the offer engine component is operable to generate, in response to a determination that product has been selected by the consumer, a further product offer associated with a further product.

17. The routing system according to claim 16, wherein the further product offer is generated based on the product selected by the consumer.

18. A method of obtaining a route of navigation at a retail premise of a merchant, said retail premise having a plurality of products located at a plurality of sub-regions of the retail premise, the method comprising:
detecting, by a positioning unit of a communication device of a consumer, an initial location corresponding to a current location of the consumer within the retail premise,
transmitting, by a communication interface of the communication device, the initial location to a routing system,
receiving, from the routing system, a product offer associated with a said product and a route of recommendation between the initial location and a target location, said target location corresponding to a location of the said product within the retail premise, and
displaying, via a graphic user interface of the communication device, the product offer and a map of the retail premise, said map comprising a visual marking of the route of recommendation.

19. The method according to claim 18, comprising the communication device transmitting a characteristic associated with the consumer to the routing system, and receiving the product offer generated based on the characteristic.

20. The method according to claim 18, comprising receiving product information indicating one or more products selected by the consumer at the retail premise in real time.
